(19) United States
(12) Patent Application Publication
(10) Pub. No.: US 2009/0323349 A1
(43) Pub. Date: Dec. 31, 2009

(54) LIGHTING APPARATUS

(75) Inventor: Tsutomu Ochiai, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YAMAGATA PROMOTIONAL ORGANIZATION FOR INDUSTRIAL TECHNOLOGY, Yamagata-shi (JP)

(21) Appl. No.: 12/492,287

(22) Filed: Jun. 26, 2009

(30) Foreign Application Priority Data
Jun. 27, 2008 (JP) 2008-168799

(51) Int. Cl. F21V 7/00; F21V 3/00; H01J 1/62

(52) U.S. Cl. 362/296.01; 362/311.01; 313/504

(57) ABSTRACT

A lighting apparatus includes a plane light-emitter 1 and a lighting device body 5 for distributing and guiding light. The above-mentioned lighting device body 5 is provided with a lighting device attachment member 6 mounted to the plane light-emitter so as to surround a luminescence side of the plane light-emitter 1, a first light guidance member 7 which is constituted by a window hole adjoining the above-mentioned lighting device attachment member and passes the above-mentioned emitted light in a direction which does not intersect perpendicularly with the luminescence side of the above-mentioned plane light-emitter, and a second light guidance member 8 which is formed in the shape of a cylinder adjoining the above-mentioned first light guidance member and passes the above-mentioned emitted light directed toward the inside of a cylinder in a direction which intersects perpendicularly with the luminescence side of the above-mentioned plane light-emitter.

### BACKGROUND OF THE INVENTION

1. Field of the Invention

The present invention relates to a lighting apparatus which uses a plane light-emitter represented by an organic EL (electroluminescence) element as a light source, is provided with a cylindrical light distribution control member for carrying out light distribution control of the light from the above-mentioned plane light-emitter, and can thus be used as, for example, a down light.

2. Description of the Related Art

In various stores, show windows, entrance halls, offices, etc., down lights which mainly illuminate areas immediately below them are used conventionally. Further, due to diversification of a lifestyle in these days, there is a trend towards the adoption of the above-mentioned down light even in some general residences.

One example of the above-mentioned conventional down light is provided which is embedded in a ceiling side, therefore it is necessary to provide an opening for installation in order to install it in the ceiling side, and construction work is needed when installing the down light. Thus, it is impossible to install this when it is difficult to bore the ceiling side.

Further, an incandescence lamp, a halogen lamp, etc., is used for the light source, therefore it is necessary for the above-mentioned conventional down light to take care of heat generation from the above-mentioned light source. An example of the proposed care is one in which a large number of heat sink fins are provided for the back of the main part of an instrument (see Japanese Patent Application Publication (KOKAI) No. H5-47208 and Japanese Patent Application Publication (KOKAI) No. H9-293410). Another example is one which is arranged to attach a heat insulating board having a comparatively large area to the back of the main part of an instrument (see Japanese Patent Application Publication (KOKAI) No. 2007-95394).

According to the down lights disclosed in Japanese Patent Application Publication (KOKAI) No. H5-47208, Japanese Patent Application Publication (KOKAI) No. H9-293410, and Japanese Patent Application Publication No. 2007-95394, they are arranged to have an additional device for coping with the heat generation from the light source, thus increasing in size. When a space above a ceiling is shallow, there are many constraints on attachment of the down lights. For example, they cannot be attached etc.

On the other hand, the above-mentioned down lights are mainly dedicated to have functions to illuminate the areas immediately below them in the shape of a spot, and properly used so that the whole room including the ceiling side may be illuminated with other lights. For this reason, it is necessary to use the down light together with other lights which illuminate the whole room, and there is a need for functioning as the down light and indirect illumination including the ceiling side by means of one device.

### SUMMARY OF THE INVENTION

The present invention arises in view of the above-mentioned problem of the conventional ones and the above-mentioned need, and aims at providing a lighting apparatus which requires neither particular construction work in the case of attachment of the device nor an additional means for taking care of heat generation from a light source, achieves the function to indirectly illuminate around the attachment area in addition to the main irradiation function, and can suitably be used, for example, as the down light.

The lighting apparatus in accordance with the present invention made in order to solve the above-mentioned problem is a lighting apparatus including-a plane light-emitter used as a light source for illumination and a lighting device body for distributing and guiding light emitted from the above-mentioned plane light-emitter, the above-mentioned lighting device body being provided with a lighting device attachment member mounted to the plane light-emitter so as to surround a luminescence side of the above-mentioned plane light-emitter, a first light guidance member which is constituted by a light permeable member or a window hole adjoining the above-mentioned lighting device attachment member and passes the above-mentioned emitted light in a direction which does not intersect perpendicularly with the luminescence side of the above-mentioned plane light-emitter, and a second light guidance member which is formed in the shape of a cylinder adjoining the above-mentioned first light guidance member and passes the above-mentioned emitted light directed toward the inside of a cylinder in a direction which intersects perpendicularly with the luminescence side of the above-mentioned plane light-emitter.

In this case, in one preferred embodiment, louvers having formed thereon partitioning sides in the direction which intersects perpendicularly with the above-mentioned plane light-emitter are arranged in the cylinder which constitutes the above-mentioned second light guidance member.

Further, in another preferred embodiment, it is arranged that a reflection member which reflects a part of light coming from the above-mentioned plane light-emitter is formed at an upper end of the cylinder which constitutes the above-mentioned second light guidance member.

In addition, desirably, it is arranged that a fixing member of a metal material is formed so as to surround the above-mentioned plane light-emitter, and the lighting device attachment member in the above-mentioned lighting device body may be detachably attached to the above-mentioned fixing member by a magnetic fixing means.

Further, it is possible to suitably employ an organic EL element as the above-mentioned plane light-emitter.

Since the lighting apparatus having the above-mentioned structure is arranged such that the first light guidance member is constituted by the light permeable member or the window hole so as to pass the emitted light from the plane light-emitter in the direction which does not intersect perpendicularly with the luminescence side, it can achieve the function to illuminate the ceiling side indirectly with faint light. Further, the second light guidance member is formed in the shape of a cylinder and the emitted light in the direction which intersects perpendicularly with the luminescence side of the above-mentioned plane light-emitter operates to pass through the above-mentioned cylinder, thus achieving the function as the down light having a predetermined cutoff angle and providing the lighting apparatus excellent also in a decoration effect.

In addition, by employing the organic EL element as the above-mentioned plane light-emitter, it is possible to obtain high luminous efficiency without generating heat, and a special feature of allowing light weight and thinning can be employed efficiently as it is. Thus, it requires neither the particular construction work in the case of attachment of the device nor the additional means for taking care of heat generation from the light source.

Further, it is arranged that the fixing member is constituted by the metal member so as to surround the above-mentioned plane light-emitter and the lighting device body provided with the above-mentioned first and second light guidance members is detachably attached by the magnetic fixing means, thus the handling in the case of cleaning, for example, the lighting device body etc. can be made easy.

### BRIEF DESCRIPTION OF THE DRAWINGS

FIG. 1A is a sectional view showing a situation where a lighting apparatus in a first preferred embodiment in accordance with the present invention is attached.

Similarly, FIG. 1B is a bottom plan view from below of the lighting apparatus.

Similarly, FIG. 1C is a perspective view from above of the lighting device body at some angle.

FIG. 2 is a schematic view for explaining an example of a structure of an organic EL element as a plane light-emitter.

FIG. 3A is sectional view showing a situation where the lighting apparatus in a second preferred embodiment in accordance with the present invention is attached.

Similarly, FIG. 3B is a bottom plan view from below of the lighting apparatus.

Similarly, FIG. 3C is a perspective view from above of the lighting device body at some angle.

FIG. 4A is a sectional view showing a situation where the lighting apparatus in a third preferred embodiment in accordance with the present invention is attached.

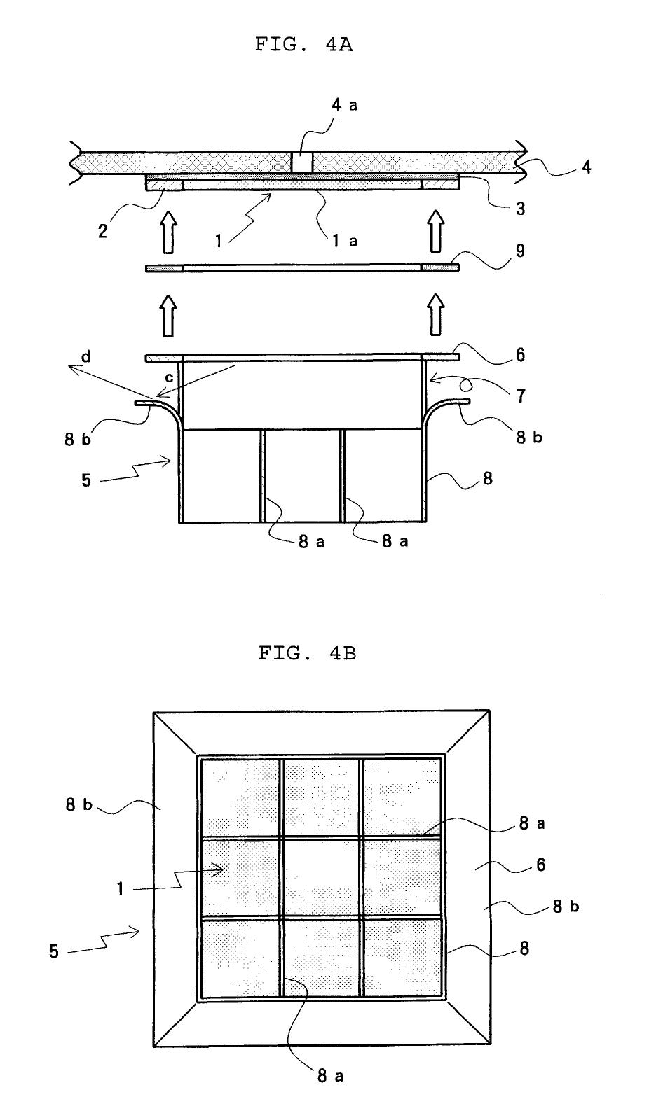

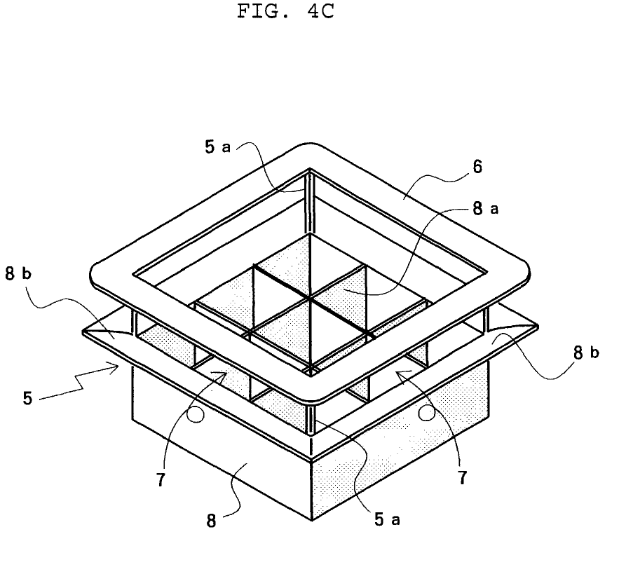

Similarly, FIG. 4B is a bottom plan view from below of the lighting apparatus.

Similarly, FIG. 4C is a perspective view from above of the lighting device body at some angle.

### DESCRIPTION OF THE PREFERRED EMBODIMENTS

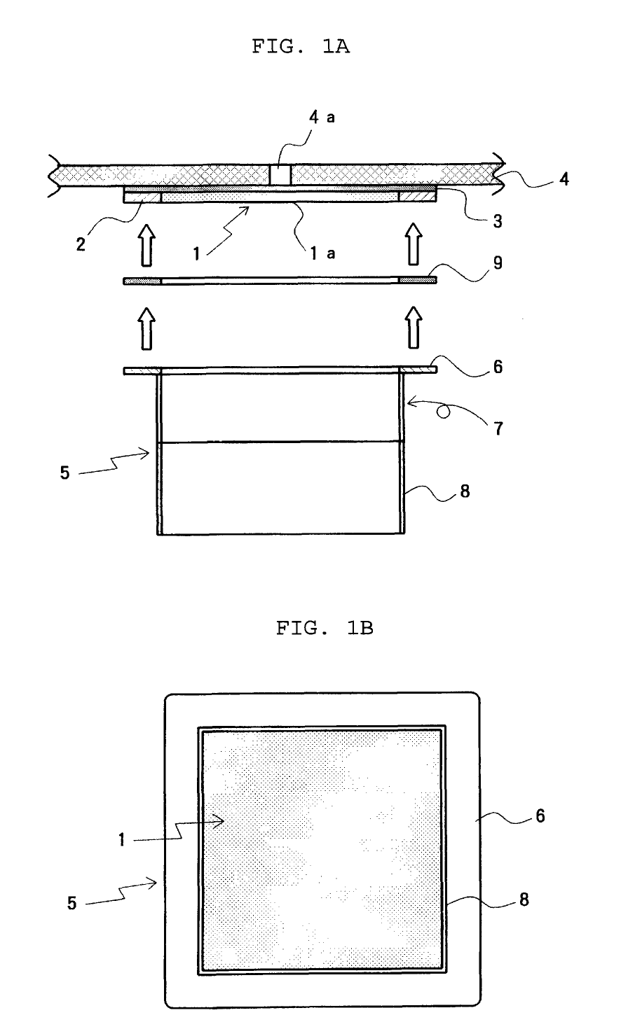

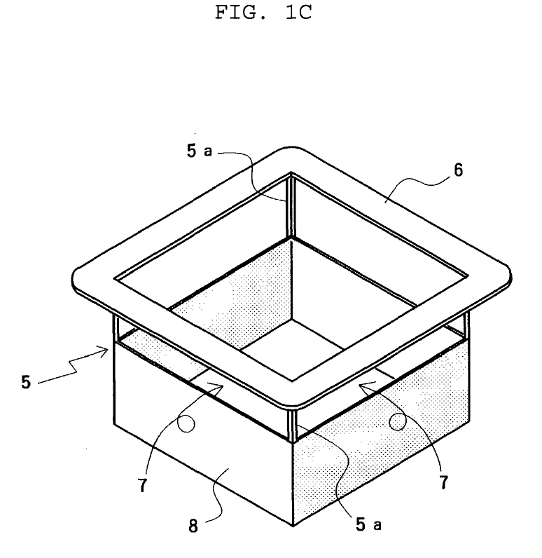

Hereafter, a lighting apparatus in accordance with the present invention will be described with reference to the preferred embodiments as shown in the drawings. FIGS. 1A-1C illustrate a first preferred embodiment of the lighting apparatus. FIG. 1A is a sectional view showing a situation where a plane light-emitter is constituted by an organic EL element, and a lighting device body are attached to, for example, a ceiling side in order. FIG. 1B is a bottom plan view from below of the lighting apparatus. FIG. 1C is a perspective view from above of the lighting device body at some angle.

As shown in FIGS. 1A and 1B, a plane light-emitter 1 is constituted by the organic EL element formed in the shape of a rectangle. As shown in FIG. 1A, a fixing member 2 made of a metal material is attached so that four sides of the above-mentioned plane light-emitter 1 may be surrounded. As a luminescence side la of the plane light-emitter 1 faces downward, its back is attached to an attachment side 4, such as a ceiling, through an adhesive sheet 3. Further, the above-mentioned attachment side 4 is provided, if needed, with an opening 4a through which an electric supply line (not shown) for supplying electric power to the above-mentioned organic EL element as the plane light-emitter 1 is threaded.

In addition, in the case where the above-mentioned attachment side 4 is made of the metal material, the magnet sheet is used instead of the above-mentioned adhesive sheet 3, so that the plane light-emitter 1 can be attached to the above-mentioned attachment side 4 by means of the above-mentioned fixing member 2 which surrounds the four sides of the plane light-emitter 1.

A lighting device body as indicated by reference numeral 5 is attached to the above-mentioned plane light-emitter 1 which is attached to the attachment side 4 as described above. As shown also in FIGS. 1B and 1C, this lighting device body 5 is provided with a lighting device attachment member 6 mounted to the plane light-emitter 1 so as to surround the luminescence side 1a of the above-mentioned plane light-emitter 1.

This lighting device attachment member 6 is formed to have a rectangular opening and a size similar to that of the above-mentioned fixing member 2 attached so as to surround the four sides of the above-mentioned plane light-emitter 1. Therefore, by forming the lighting device attachment member 6 from a metal material, the lighting device body 5 can be attached to the fixing member 2 of the plane light-emitter 1 through a magnet sheet (a magnetic fixing means) as indicated by reference numeral 9 and having formed therein the rectangular opening.

The above-mentioned lighting device body 5 has formed therein a first light guidance member 7 for passing the emitted light in a direction which does not intersect perpendicularly with the luminescence side 1a of the above-mentioned plane light-emitter 1. In other words, as shown in FIG. 1C, the first light guidance member 7 is constituted by window holes partitioned by four rib members 5a which connect the lighting device attachment member 6 with a second light guidance member 8 in the shape of a cylinder, as will be described later.

Further, the above-mentioned second light guidance member 8 is constituted by a rectangular cylinder (indicated by the same reference numeral 8 as that of the second light guidance member), and functions to pass the emitted light which is directed toward the inside of the cylinder and is in a direction intersecting perpendicularly with the luminescence side 1a of the above-mentioned plane light-emitter 1. In other words, by forming the above-mentioned cylinder 8 to have a predetermined length, the light emitted from the above-mentioned plane light-emitter 1 is projected downward at a predetermined cutoff angle, and it acts so as to achieve the function as a down light.

In addition, preferably the above-mentioned lighting device body 5 is formed by bending a metal plate whose overall thickness is thin (for example, approximately 0.8 mm), and it is arranged to be subjected to baking finish with melamine resin, for example. Therefore, the lighting device body 5 can be formed to be lightweight, and as shown by way of illustration it can be detachably attached to the ceiling side etc. by means of the magnet sheet 9.

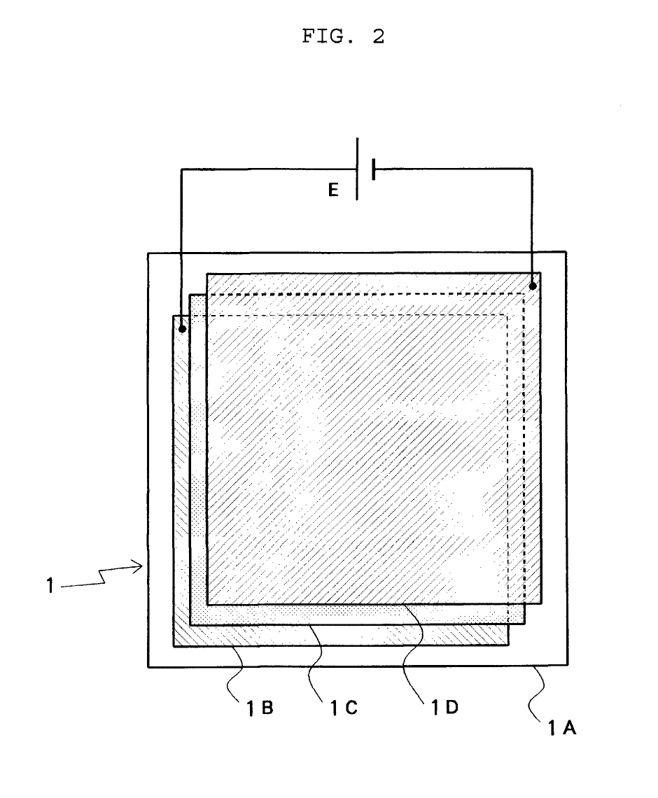

FIG. 2 is for explaining an example of a structure of the organic EL element (indicated by the same reference numeral 1 as that of the plane light-emitter) as the above-mentioned plane light-emitter 1. In FIG. 2, it is illustrated in a situation where respective layers constituting the organic EL element 1 are separated in a layer direction. In other words, as for the organic EL element 1 of this type, a transparent electrode 1B made of ITO (for example) used as a first electrode is formed at one side of a substrate 1A formed of a transparent material, such as for example glass.

Further, an organic luminescence layer 1C is formed as a film so as to be stacked on the above-mentioned transparent electrode 1B. Although this organic luminescence layer is constituted by, for example, a hole transport layer, a luminescence layer, an electronic transport layer, etc., it is represented by the organic luminescence layer 1C with one layer in the drawing. A counter electrode 1D which serves as a second electrode and is made of aluminum etc., for example, is formed so as to be stacked on the above-mentioned organic luminescence layer 1C.

In addition to this, although not shown in the drawings, a sealing substrate is disposed at the back side of the counter electrode 1D, and this sealing substrate is sealed by a sealing member at a circumferential edge of the above-mentioned glass substrate 1A on a front side.

A direct-current power source E is connected between the above-mentioned transparent electrode 1B and the counter electrode 1D, whereby a portion sandwiched between the above-mentioned transparent electrode 1B and the counter electrode 1D at the organic luminescence layer 1C emits light which is conducted to the outside through the above-mentioned transparent electrode 1B and the glass substrate 1A.

The above-mentioned organic EL element 1 is characterized in that it is driven by a low D/C voltage to provide high luminous efficiency and allow light weight and thinning and that heat is not substantially generated, thus being suitably applied to the lighting apparatus in accordance with the present invention.

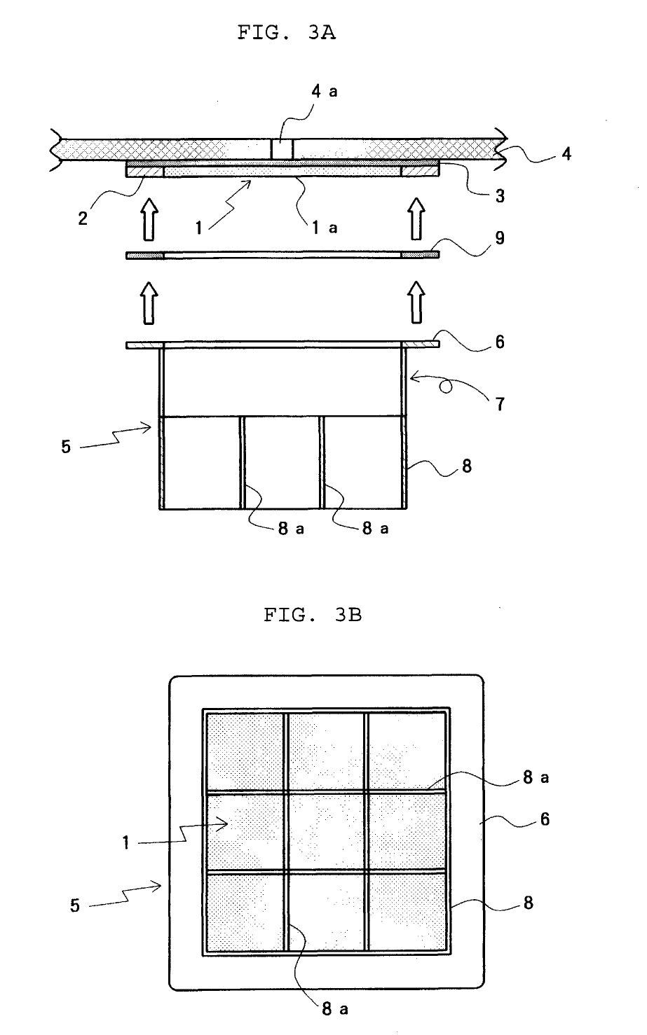

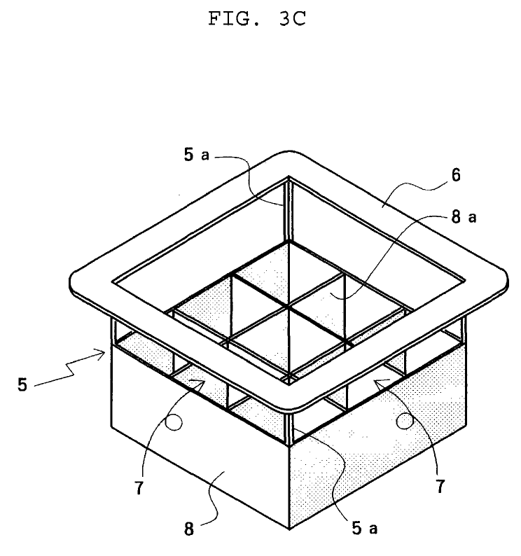

Next, FIGS. 3A-3C show a second preferred embodiment of the lighting apparatus in accordance with the present invention. Each of these drawings is an illustration similar to that for the first preferred embodiment as already described with reference to FIGS. 1A-1C. The same reference numerals are used for components that achieve the functions similar to those in the first preferred embodiment as described with reference to FIGS. 1A-1C, therefore the detailed description will not be repeated.

In the second preferred embodiment as shown in FIGS. 3A-3C, louvers 8a having formed thereon partitioning sides in the direction which intersects perpendicularly with the luminescence side 1a of the above-mentioned organic EL element 1 as the plane light-emitter are arranged in the rectangular cylinder 8 which constitutes the second light guidance member. In other words, the louvers 8a in this preferred embodiment are arranged such that the inside of the rectangular cylinder 8 is divided into nine parts as described in FIG. 4B.

Therefore, with the above-mentioned louvers 8a, the light emitted from the above-mentioned organic EL element 1 as the plane light-emitter can be projected below at a narrower cutoff angle, and the function to illuminate the areas immediately below them in the shape of a spot with a smaller size can be provided.

FIGS. 4A-4C show a third preferred embodiment of the lighting apparatus in accordance with the present invention. Each of these drawings is an illustration similar to that for the first or second preferred embodiment as already described with reference to FIGS. 1A-1C or FIGS. 3A-3C. The same reference numerals are used for components that achieve the functions similar to those in the first and second preferred embodiments, and therefore the detailed description will not be repeated.

In the third preferred embodiment as shown in FIGS. 4A-4C, a reflection member 8b which reflects a part of light coming from the organic EL element 1 as the above-mentioned plane light-emitter is formed at an upper end of the cylinder 8 which constitutes the second light guidance member. In other words, in the preferred embodiment as shown in the drawings, the upper end of the above-mentioned cylinder 8 formed in the shape of a rectangle is formed to curve horizontally toward the outside of the cylinder 8, and a flange portion which is horizontally formed constitutes the above-mentioned reflection member 8b.

Therefore, according to the above-mentioned structure, as shown in FIG. 4A, a part of light which is from the plane light-emitter 1 and passes through the second light guidance member 8 constituted by the window holes is reflected, as shown by arrow c, by the reflection member 8b formed in the shape of a flange, and is projected, as shown by arrow d, toward the attachment side 4 of the plane light-emitter 1. Therefore, in the case of attaching the lighting device body 5 to the ceiling side, a part of light from the plane light-emitter 1 reaches the ceiling side and can increase a degree of the indirect illumination.

As is clear from the above description, the lighting apparatus in accordance with the present invention is constituted by the plane light-emitter 1 and the lighting device body 5, and the above-mentioned lighting device body 5 is provided with the lighting device attachment member, the first light guidance member, and the second light guidance member, so that a part of light from the above-mentioned plane light-emitter is allowed to achieve the function to illuminate the lighting device attachment side (ceiling side) with the faint light and to have the function as the down light having a predetermined cutoff angle.

Further, as described above, it is possible to obtain operational effects. For example, it requires neither the particular construction work in the case of attachment of the device nor the additional means for taking care of heat generation from the light source.

In addition, in the preferred embodiments as described above, although the cylinder body which constitutes the second light guidance member in the lighting device body is made in the shape of a rectangle, it is possible to select, for example, a cylindrical shape or other shapes. Similarly, the shape of the louvers may not be parallel crossed, but can be formed concentrically with the cylinder body, for example.

Further, in the preferred embodiments, although the first light guidance member 7 is constituted by the window holes divided by the four rib members 5a which connect the lighting device attachment member 6 and the cylindrical second light guidance member 8, it can also be made of a light permeable material, such as for example Japanese paper or a synthetic resin, according to usage. Furthermore, it may also be arranged such that a plate-like light permeable member is fitted into the above-mentioned window hole.

Still further, in the above description, although the example is shown in which the plane light-emitter 1 of the lighting apparatus in accordance with the present invention is attached to the ceiling side and used as the down light, it is also possible to attach this plane light-emitter 1 to a wall surface (side wall). It is further possible to attach the above-mentioned plane light-emitter 1 to a tip of a support (for example), and to use it so as to function as a stand light or a spotlight.

Furthermore, in the lighting apparatus in accordance with the present invention, the organic EL element is desirably used as the plane light-emitter. In addition to this, however, it is also possible to use a plane light-emitting element, such as an inorganic EL element.

What is claimed is:

1. A lighting apparatus having a plane light-emitter used as a light source for illumination and a lighting device body for distributing and guiding light emitted from said plane light-emitter,
said lighting device body being provided with a lighting device attachment member mounted to the plane light-emitter so as to surround a luminescence side of said plane light-emitter,
a first light guidance member which is constituted by a light permeable member or a window hole adjoining said lighting device attachment member and passes said emitted light in a direction which does not intersect perpendicularly with the luminescence side of said plane light-emitter, and
a second light guidance member which is formed in the shape of a cylinder adjoining said first light guidance member and passes said emitted light directed toward the inside of a cylinder in a direction which intersects perpendicularly with the luminescence side of said plane light-emitter.

2. The lighting apparatus as claimed in claim 1, wherein louvers having formed thereon partitioning sides in a direction which intersects perpendicularly with said plane light-emitter are arranged in the cylinder which constitutes said second light guidance member.

3. The lighting apparatus as claimed in claim 1 or 2, wherein a reflection member for reflecting a part of light coming from said plane light-emitter is formed at an upper end of the cylinder which constitutes said second light guidance member.

4. The lighting apparatus as claimed in claim 1, wherein a fixing member made of a metal material is formed so as to surround said plane light-emitter and the lighting device attachment member in said lighting device body is detachably attached to said fixing member by a magnetic fixing means.

5. The lighting apparatus as claimed in claim 1, wherein said plane light-emitter is constituted by an organic EL element.
